(19) United States
(12) Patent Application Publication
(10) Pub. No.: US 2026/0178832 A1
(43) Pub. Date: Jun. 25, 2026

(54) SELECTIVE RECOMPUTATION OF KEY VALUE DATA

(71) Applicant: ADVANCED MICRO DEVICES, INC., Santa Clara, CA (US)

(72) Inventors: Shaizeen Aga, Santa Clara, CA (US); Akila Subramaniam, Austin, TX (US); Suchita Pati, Santa Clara, CA (US)

(21) Appl. No.: 19/000,019

(22) Filed: Dec. 23, 2024

(51) Int. Cl. G06F 40/284; G06F 16/22

(52) U.S. Cl. CPC G06F 40/284; G06F 16/2237

(57) ABSTRACT

A processing system executing a generative artificial intelligence model generates keys and values (KV vectors) just in time for consumption by a layer of the model by selectively recomputing keys and values that were computed in a previous layer of the model rather than storing the keys and values for consumption by subsequent layers.

### BACKGROUND

Generative artificial intelligence (AI) inferencing such as large language model (LLM) inferencing involves utilizing a pre-trained model to generate output text (e.g., responses to questions, text to complete a sentence, a summarization of text, etc.) based on input text (e.g., a question, an initial segment of a sentence, text to be summarized, etc.). The process of LLM inferencing includes generating tokens (small units of text) based on key and value pairs (KV vectors) based on the input text and the LLM's vocabulary, passing the tokens through multiple layers of one or more neural networks for processing to generate output tokens, and decoding the output tokens into coherent output text.

Interest has grown in executing generative AI inference models on devices that have the compute capacity, bandwidth, and storage capacity equivalent to discrete parallel processors such as graphics processing units (GPUs) while handling large batch sizes. As the length of the input text and/or batch size increases, the amount of memory required to store KV vectors increases. If the amount of KV vectors (referred to herein as KV cache) exceeds the size of available device memory, the KV cache spills out of device memory to host memory, incurring costly data movement.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system configured to selectively discard and recompute key and value vectors for a generative artificial intelligence model in accordance with some embodiments.

FIG. 2 is a diagram illustrating computation and storage of key and value vectors for prefill and decode phases of a generative artificial intelligence model.

FIGS. 3 and 4 are diagrams illustrating selective discarding and recomputation of prefill key and value vectors in decode phases of a generative artificial intelligence model in accordance with some embodiments.

FIGS. 5 and 6 are diagrams illustrating selective discarding and recomputation of prefill and decode key and value vectors in subsequent decode phases of a generative artificial intelligence model in accordance with some embodiments.

FIG. 7 is a flow diagram illustrating a method for selectively discarding and recomputing prefill and/or decode key and value vectors in decode phases of a generative artificial intelligence model in accordance with some embodiments.

### DETAILED DESCRIPTION

The execution of LLM models typically comprises two phases: a prefill phase and a decode phase. The prefill phase operates on a vector of words in order to understand the context. As used herein, context refers to the informational background or the set of circumstances surrounding a specific piece of data, event, or computational process that influences its interpretation, processing, or outcome within a neural network, such as LLMs. In certain scenarios and embodiments, context encompasses some or all of the preceding elements and, in some models, some or all succeeding elements (such as words, tokens, or vector embeddings) that provide semantic or syntactic clues utilized for accurately predicting, generating, or understanding a current element or sequence of elements. Context guides a neural network model to generate coherent, relevant, and semantically rich outputs based on the input it receives. In LLMs, the effective leveraging and manipulation of context enable the models to exhibit a deep understanding of language nuances, grammar, and relationships between concepts, thereby enhancing their ability to perform a wide range of tasks from translation to content creation and beyond. The depth and breadth of context considered by a model greatly impact its performance and the complexity of the tasks it can effectively process.

In the decode phase, the model generates output, typically one token at a time, by leveraging the context established in the preceding phase or phases. During this decode phase, the model iteratively utilizes the contextual information accumulated from a prefill phase to predict or generate the subsequent element in a sequence. This phase is characterized by the model's application of its learned parameters and the structural intricacies of its architecture—such as attention blocks and MLP blocks—to infer the most probable subsequent token based on the provided context. The decode phase is operative for the model's generative tasks. In executing the decode phase, the model generally caches previous contexts and dynamically integrates them with the current state to produce outputs that are coherent, contextually relevant, and semantically rich.

The context is represented by KV vectors in which the keys are input sequences or tokens and the values are the corresponding output representations. Each of the prefill and decode phases processes model layers (e.g., L1, L2) one by one, reading in model weights and creating intermediate data such as activations and KV vectors, which are stored as KV cache. While activations are discarded after use, the KV cache is typically preserved across phases. The KV vectors are created by matrix-matrix or matrix-vector computations in the K and V linear layers and are consumed by attention layers.

As the decode phase processes each input token and previously-generated KV vectors, the decode phase stores the corresponding output representation as KV cache. Depending on the length of a text input (prefill size, or input prompt size) and a number of users or sessions being concurrently executed at a generative AI inference model (referred to herein as a batch size), the KV cache size can grow large enough to stress the available memory capacity. A device executing an generative AI inference model may have high compute bandwidth (as measured in trillions of operations per second, or TOPS) and memory bandwidth capabilities but lack memory capacity. If the KV cache exceeds the memory capacity of the device, the KV cache will spill out of device memory to host memory, resulting in decreased performance and longer latency.

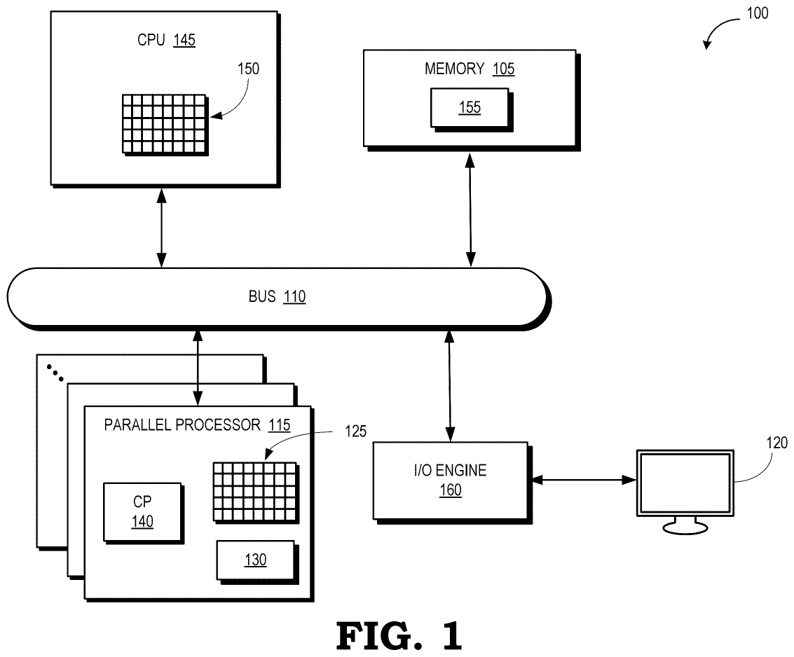

To alleviate stress on device memory, FIG. 1-7 illustrate techniques for generating keys and values just in time for consumption by a layer of a generative AI inference model by selectively recomputing keys and values that were computed in a previous layer of the model rather than storing the keys and values as KV cache for consumption by subsequent layers. Whereas memory capacity may be constrained for many devices, compute capacity is sufficient to recompute KV vectors as needed for each layer more efficiently than storing the KV vectors that were previously computed. In some implementations, the KV vectors that were computed in a layer of the prefill phase are discarded after being used in the prefill phase to generate a first token and are selectively recomputed on a layer-by-layer basis in the decode phase prior to scheduling the decode for the layer that consumes the recomputed KV vectors. In such implementations, no KV vector storage is necessary for the prefill phase and only temporary storage is needed to hold KV vectors for a single layer as each layer progresses.

If memory constraints permit, in some implementations multiple layers are coalesced for re-computation of prefill KV vectors rather than selectively recomputing prefill KV vectors one layer at a time. Alternatively, the prefill KV vectors of some layers persist in the KV cache such that re-computation for those layers is skipped, if memory constraints allow it. Thus, selectively re-computation of prefill KV vectors is opportunistically employed in some implementations based on model size and system parameters such as cache sizes.

In some implementations, the amount of KV vectors stored as KV cache can be further lowered by selectively re-computing KV vectors that were previously computed in a layer of the decode phase, in addition to selectively re-computing KV vectors that were previously computed in a layer of the prefill phase. In such implementations, before scheduling decode computation for a given token, the Query Key Value (QKV) calculation computation for all previous tokens for a current layer is pre-scheduled using preserved input tokens to produce the KV vectors necessary to launch the decode computation for the current token and layer. Similar to selective prefill recomputation described above, selective decode recomputation of KV vectors is opportunistically employed in some implementations based on model size and system parameters such as cache sizes.

FIG. 1 is a block diagram of a processing system 100 configured to selectively discard and recompute key and value vectors for a generative artificial intelligence model in accordance with some embodiments. The processing system 100 is generally designed to execute sets of instructions or commands to carry out tasks on behalf of an electronic device, such as a desktop computer, laptop computer, server, smartphone, tablet, game console, and the like.

The processing system 100 includes or has access to a memory 105 or other storage component that is implemented using a non-transitory computer readable medium, such as dynamic random access memory (DRAM). The processing system 100 also includes a bus 110 to support communication between entities implemented in the processing system 100, such as the memory 105. In certain embodiments, the processing system 100 includes other buses, bridges, switches, routers, and the like, which are not shown in FIG. 1 in the interest of clarity.

The processing system 100 includes one or more parallel processors 115 that are configured to render images for presentation on a display 120. A parallel processor is a processor that is able to execute a single instruction on multiple data or threads in a parallel manner. Examples of parallel processors include graphics processing units (GPUs), massively parallel processors, single instruction multiple data (SIMD) architecture processors, and single instruction multiple thread (SIMT) architecture processors for performing graphics, machine intelligence, or compute operations. The parallel processor 115 can render objects to produce pixel values that are provided to the display 120. In some implementations, parallel processors are separate devices that are included as part of a computer. In other implementations such as advance processor units, parallel processors are included in a single device along with a host processor such as a central processor unit (CPU). Thus, although embodiments described herein may utilize a graphics processing unit (GPU) for illustration purposes, various embodiments and implementations are applicable to other types of parallel processors.

In certain embodiments, the parallel processor 115 is also used for general-purpose computing. For instance, the parallel processor 115 can be used to implement machine learning algorithms such as one or more implementations of a neural network as described herein. In some cases, operations of multiple parallel processors 115 are coordinated to execute a machine learning algorithm, such as if a single parallel processor 115 does not possess enough processing power to run the machine learning algorithm on its own.

The parallel processor 115 implements multiple processing elements (also referred to as compute units) 125 that are configured to execute instructions concurrently or in parallel. The parallel processor 115 also includes an internal (or on-chip) memory 130 (also referred to herein as device memory) that includes a local data store (LDS), as well as caches, registers, or buffers utilized by the compute units 125. The parallel processor 115 can execute instructions stored in the memory 105 and store information in the memory 105 such as the results of the executed instructions. The parallel processor 115 also includes a command processor 140 that receives task requests and dispatches tasks to one or more of the compute units 125.

The processing system 100 also includes a central processing unit (CPU) 145 that is connected to the bus 110 and communicates with the parallel processor 115 and the memory 105 via the bus 110. The CPU 145 implements multiple processing elements (also referred to as processor cores) 150 that are configured to execute instructions concurrently or in parallel. The CPU 145 can execute instructions such as program code 155 stored in the memory 105 and the CPU 145 can store information in the memory 105 such as the results of the executed instructions.

An input/output (I/O) engine 160 handles input or output operations associated with the display 120, as well as other elements of the processing system 100 such as keyboards, mice, printers, external disks, and the like. The I/O engine 160 is coupled to the bus 110 so that the I/O engine 160 communicates with the memory 105, the parallel processor 115, or the CPU 145.

In operation, the CPU 145 issues commands to the parallel processor 115 to initiate processing of a kernel that represents the program instructions that are executed by the parallel processor 115. Multiple instances of the kernel, referred to herein as threads or work items, are executed concurrently or in parallel using subsets of the compute units 125. In some embodiments, the threads execute according to single-instruction-multiple-data (SIMD) protocols so that each thread executes the same instruction on different data. The threads are collected into workgroups (also termed thread groups) that are executed on different compute units 125. For example, the command processor 140 can receive these commands and schedule tasks for execution on the compute units 125.

As used herein, a layer in a neural network is a hardware- or software-implemented construct in a processing system, such as processing system 100. In various embodiments, such a layer may perform one or more operations via processing circuitry of the processing system 100 to serve as a collection or group of interconnected neurons or nodes, arranged in a structure that can be optimized for execution on one or more parallel processors (e.g., parallel processors 115) or other similar computation units. Such computation units can, in certain embodiments, comprise one or more graphics processing units (GPUs), massively parallel processors, single instruction multiple data (SIMD) architecture processors, and single instruction multiple thread (SIMT) architecture processors.

Each layer processes and transforms input data—for example, raw data input into an input layer or the transformed data passed between hidden layers. This transformation process involves the use of a weight matrix, which is held in memory (e.g., memory 105) and manipulated by the central processing unit (CPU) 145 and/or the parallel processors 115.

In some instances, such layers may be distributed across multiple processing units within a system. For instance, different layers or groups of layers may be executed on different compute units 125 within a single parallel processor 115, or even across multiple parallel processors if warranted by system architecture and the complexity of the neural network.

The output of each layer, after processing and transformation, serves as input for the subsequent layer. In the case of the final output layer, it produces the results or predictions of the neural network. In various embodiments, such results can be utilized by the system or fed back into the network as part of a training or fine-tuning process. In some embodiments, the training or fine-tuning process involves adjusting one or more weights in the output weight matrix associated with each layer to improve performance of the neural network.

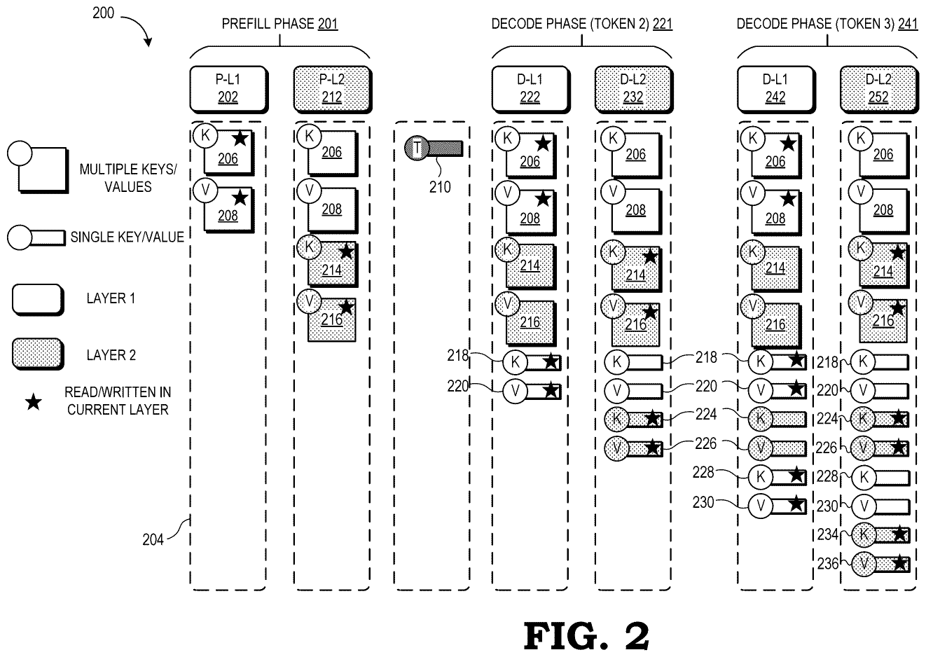

FIG. 2 is a diagram illustrating a generative AI model 200 computing and storing key and value vectors for prefill and decode phases of the generative AI model 200. In the illustrated example, the AI model 200 includes two layers: layer 1 and layer 2. The first layer of the generative AI model 200 executes the prefill phase (P-L1) 202 to perform multiple functions, such as QKV calculations to compute KV values 206, 208 that are stored as KV cache 204 and attention computations that consume the KV cache 204, as well as fully-connected layers. The output of P-L1 202 feeds into the second layer, which executes the prefill phase (P-L2) 212, to consume the output of P-L1 202 and perform the same functions as P-L1 202.

Because the prefill phase 201 operates on a vector of input words (e.g., an entire text string of a query), each of which results in, e.g., one key and one value, the prefill phase 201 generates on average many keys and values that form the KV cache. For example, if the input query is “What are the best places to vacation in the Bay Area?”, each word of the query results in a key and a value. In the illustrated example, P-L1 202 generates a plurality of keys 206 and a plurality of values 208 that will subsequently be consumed by the first layer when it executes the decode phase for each token. The keys 206 and values 208 are stored as KV cache 204 while the second layer's execution of the prefill phase P-L2 212 in turn generates a plurality of keys 214 and a plurality of values 216 that will subsequently be consumed by the second layer's execution of the decode phase for each token. The output of the prefill phase 201 is a first token 210. In the example of the input query “What are the best places to vacation in the Bay Area?”, the first token 210 may be the word “The”, which is the first word of an answer that a LLM might generate in response to the query.

Whereas each layer's execution of the prefill phase 201 generates multiple keys and values (e.g., one of each for each word of the input query), the first token 210 is input to the first layer during the decode phase, which generates a single key and a single token for each batch. For example, the first layer executes the decode phase (D-L1) 222 by reading the plurality of keys 206 and values 208 that were generated in the prefill phase P-L1 202 and based on those KV vectors and the first token 210, generating a key 218 and a value 220. Although the plurality of keys 214 and the plurality of values 216 that were generated in the prefill phase P-L2 212 are not read in the first layer's execution of the decode phase 221, they remain in the KV cache 204. Thus, for the first layer's execution of the decode phase D-L1 222, the KV cache 204 includes the plurality of keys 206, the plurality of values 208, the plurality of keys 214, the plurality of values 216, the single key 218, and the single value 220.

The single key 218 and single value 220 generated in the decode phase 221 are represented by smaller boxes in FIG. 2 than the larger boxes (206, 208, 214, 216) that represent pluralities of keys and values that were generated in the prefill phase 201. In addition, whereas keys and values generated by the first layer (of either execution of the prefill phase 201 or the decode phase 221) are represented by unshaded boxes, the keys and values generated by the second layer are represented by shaded boxes. Finally, a star on a box indicates a key or value that is read or written by the current layer.

The second layer's execution of the decode phase 221 for the second token (D-L2 232) generates a single key 224 and a single value 226 based on the plurality of keys 214 and the plurality of values 216 that were generated in the second layer's execution of the prefill phase P-L2 212. The KV cache 204 for D-L2 232 includes the plurality of keys 206, the plurality of values 208, the plurality of keys 214, the plurality of values 216, the single key 218, the single value 220, the single key 224, and the single value 226.

A similar process repeats for the first layer's execution of the decode phase 241 for a third token (D-L1 242), with the KV cache 204 including all of the keys and values that were generated in previous layers as well as the single key 228 and the single value 230. Likewise, for the second layer's execution of the decode phase 241 for the third token (D-L2) 252, the KV cache 204 includes all of the keys and values that were previously generated by the first and second layers as well as the single key 234 and the single value 236. Although in the simplified example of FIG. 2, the generative AI model 200 includes only two layers, a generative AI model may have many more layers (e.g., hundreds of layers). In addition, the example of FIG. 2 shows population of the KV cache for a single user (batch size=1), whereas a generative AI model may have many users (batch size of tens, hundreds, or thousands). The efficiency of the model, as measured by model flop utilization (% MFU) increases until the KV cache 204 exceeds the storage capacity of the device memory 130. However, once the KV cache 204 exceeds the available storage capacity of the device memory 130, the KV cache 204 spills to external memory, such as memory 105. Subsequent accesses to the data stored as KV cache 204 incur latency penalties, causing the efficiency of the model to decrease significantly.

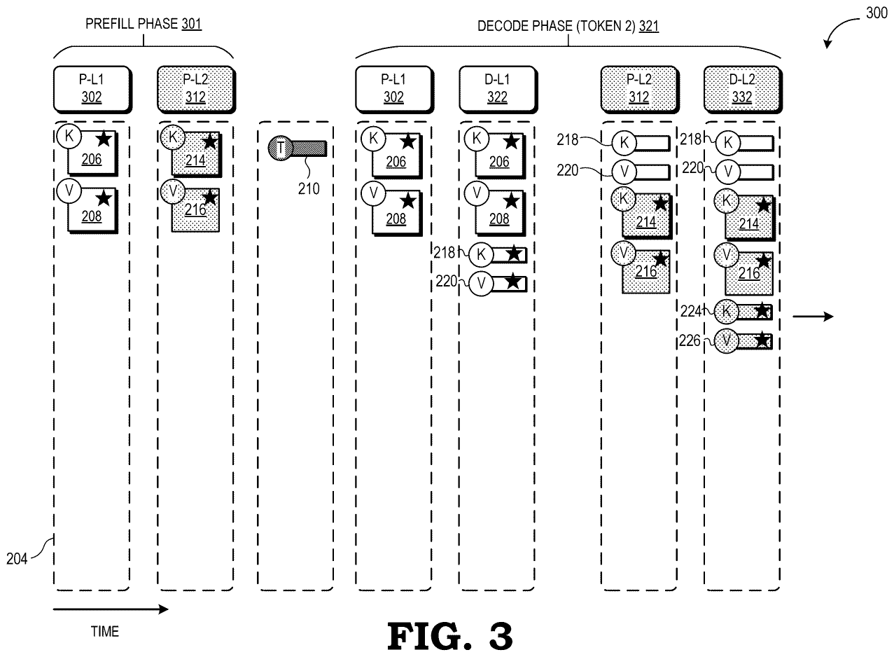

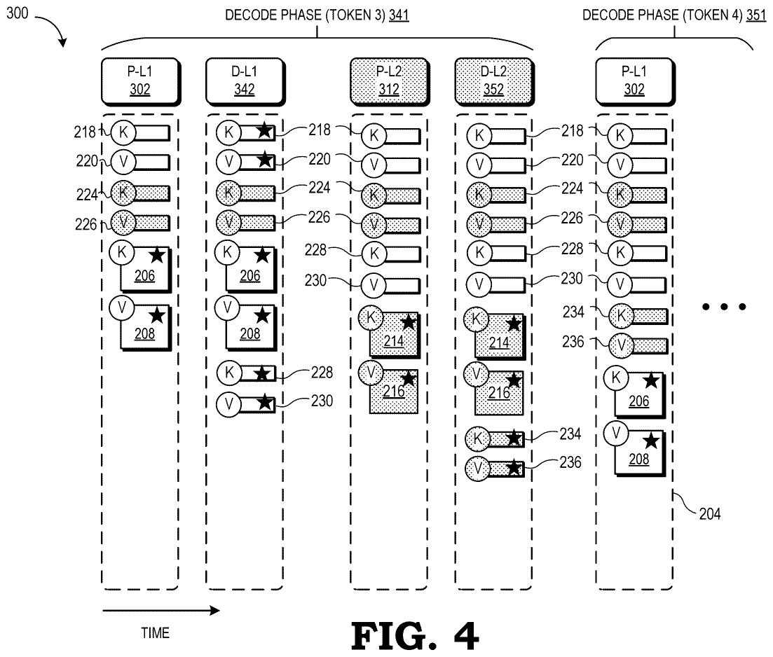

FIGS. 3 and 4 are diagrams illustrating a generative AI model 300 selectively discarding and recomputing prefill key and value vectors in decode phases of the generative AI model 300 in accordance with some embodiments. In contrast to the computation and storage of key and value vectors for prefill and decode phases of the generative AI model 200 illustrated in FIG. 2, the pluralities of keys 206, 214 and the pluralities of values 208, 216 calculated in the execution of the prefill phase 301 are not stored as KV cache 204 but are instead recomputed in the decode phases 321, 341, 351 of the generative AI model 300, significantly alleviating storage pressure at the device memory 130.

In particular, rather than storing the plurality of keys 206 and the plurality of values 208 that were generated during execution by a first layer P-L1 302 of a prefill phase 301 during execution by a second layer P-L2 312 of the prefill phase 301, the generative AI model 300 discards the plurality of keys 206 and the plurality of values 208 that were generated by execution by the first layer P-L1 302 of the prefill phase 301, leaving only the plurality of keys 214 and the plurality of values 216 in the KV cache 204 during execution by the second layer P-L2 312 of the prefill phase 301. The plurality of keys 214 and the plurality of values 216 are then discarded such that the only output of the prefill phase 301 that is stored as KV cache 204 following execution of P-L2 312 is the first token 210.

Because the first layer D-L1 322 uses the plurality of keys 206 and the plurality of values 208 as an input when executing the decode phase 321 to generate the second token and because the plurality of keys 206 and the plurality of values 208 have been discarded and not saved to device memory 130 as KV cache 204, the generative AI model 300 reinvokes the first layer P-L1 302 to execute the prefill phase 301 to recompute the plurality of keys 206 and the plurality of values 208 just in time for consumption by D-L1 322. In response to P-L1 302 recomputing the plurality of keys 206 and the plurality of values 208, the generative AI model 300 schedules execution of the decode phase 321 for the second token by the first layer D-L1 322. Execution by the first layer D-L1 322 of the decode phase 321 generates the single key 218 and the single value 220, which in the illustrated example are preserved in device memory 130 as KV cache 204 during execution by the second layer D-L2 332 of the decode phase 321.

Because the second layer D-L2 332 uses the plurality of keys 214 and the plurality of values 216 as an input when executing the decode phase 321 to generate the second token and because they are no longer resident in device memory 130, the generative AI model 300 reinvokes the second layer P-L2 312 to re-execute the prefill phase to recompute the plurality of keys 214 and the plurality of values 216 just in time for consumption by D-L2 332. In response to P-L2 312 recomputing the plurality of keys 214 and the plurality of values 216, the generative AI model 300 schedules execution by the second layer D-L2 332 of the decode phase 321. Execution by the second layer D-L2 332 of the decode phase 321 generates the single key 224 and the single value 226, which in the illustrated example are preserved in the device memory 130 as KV cache 204 during execution by the first layer D-L1 342 of a decode phase 341 to generate the third token, shown in FIG. 4.

Similar to execution by the first layer D-L1 322 of the decode phase 321, the first layer D-L1 342 uses the plurality of keys 206 and the plurality of values 208 that were generated in the first layer P-L1 302 of the prefill phase 301 as an input for execution of the decode phase 341 to generate the third token, as well as the single key 218 and the single value 220 that were generated by execution by the first layer D-L1 322 of the decode phase 321 (which were saved in the device memory 130 as KV cache 204 in the illustrated example). Because the plurality of keys 206 and the plurality of values 208 have been discarded and not saved as KV cache 204, the generative AI model 300 reinvokes the first layer P-L1 302 to re-execute the prefill phase 301 to recompute the plurality of keys 206 and the plurality of values 208 just in time for consumption by D-L1 342. In response to P-L1 302 recomputing the plurality of keys 206 and the plurality of values 208, the generative AI model 300 schedules execution by the first layer D-L1 342 of the decode phase 341. Execution by the first layer D-L1 342 of the decode phase 341 generates the single key 228 and the single value 230, which in the illustrated example are preserved as KV cache 204 stored at the device memory 130 during execution by the second layer D-L2 352 of the decode phase 341.

Similar to execution by the second layer D-L2 332 of the decode phase 321, the second layer D-L2 352 uses the plurality of keys 214 and the plurality of values 216 as an input for execution of the decode phase 341. Because they have been discarded and are no longer resident in the KV cache 204, the generative AI model 300 reinvokes the second layer P-L2 312 to re-execute the prefill phase 301 to recompute the plurality of keys 214 and the plurality of values 216 just in time for consumption by D-L2 352. In response to P-L2 312 recomputing the plurality of keys 214 and the plurality of values 216, the generative AI model 300 schedules execution of the decode phase 341 by the second layer D-L2 352. Execution of the decode phase 341 by the second layer D-L2 352 generates the single key 234 and the single value 236, which in the illustrated example are preserved as KV cache 204 stored at device memory 130 during execution of the decode phase 351 by the first layer to generate a fourth token. The process of discarding and recomputing the pluralities of keys 206, 214 and the pluralities of values 208, 216 repeats for each successive execution of the decode phase by the first and second layer, respectively, for each subsequent token. As will be apparent from a comparison of the amount of KV cache 204 for D-L2 352 of the decode phase 341 illustrated in FIG. 4 versus the amount of KV cache 204 for D-L2 252 of the decode phase 241 illustrated in FIG. 2, significant savings in KV cache 204 are achieved by selectively discarding and recomputing the KV vectors as needed, just in time for consumption by a current layer of the decode phase.

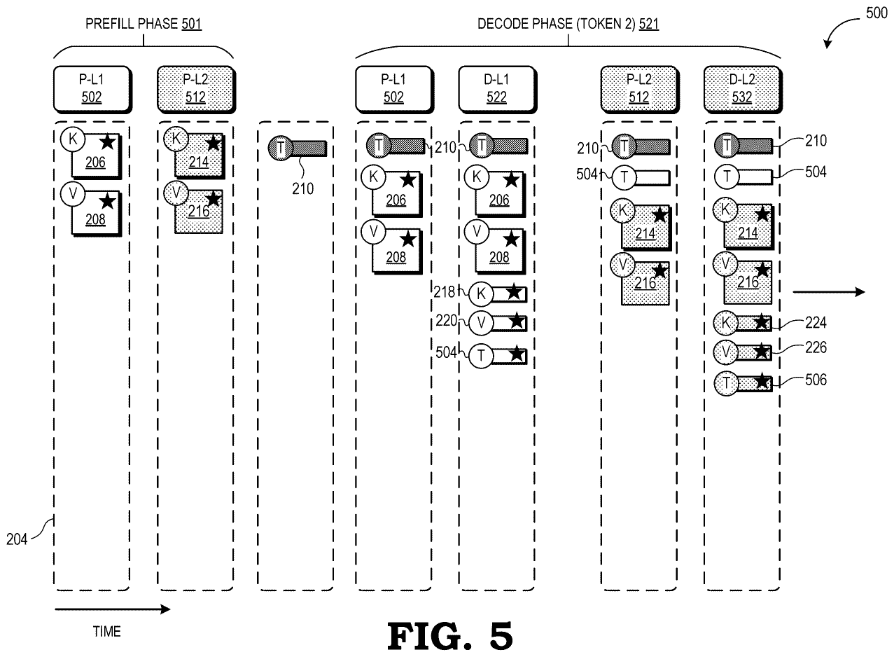

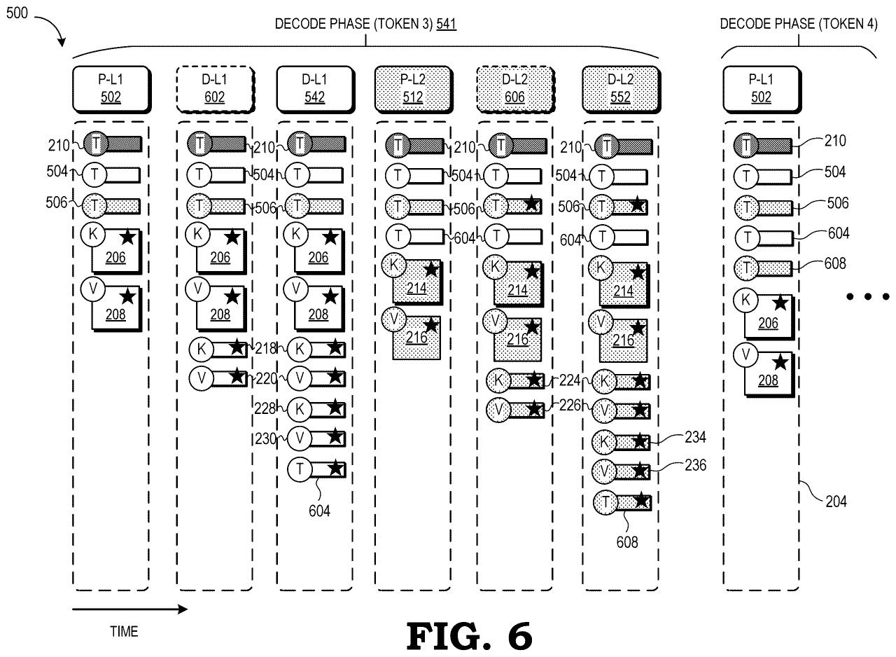

FIGS. 5 and 6 are diagrams illustrating a generative AI model 500 selectively discarding and recomputing prefill and decode key and value vectors in subsequent decode phases of the generative AI model 500 in accordance with some embodiments. Similar to the generative AI model 300 illustrated in FIGS. 3 and 4, the pluralities of keys 206, 214 and the pluralities of values 208, 216 calculated in the prefill phase 201 are not stored in device memory 130 as KV cache 204 but are instead recomputed in the decode phases of the generative AI model. In addition, whereas the generative AI model 200 saves the KV vectors generated in each decode step for every token, the generative AI model 500 selectively discards and recomputes the single keys and single values generated during execution of the decode phase on an as-needed, just-in-time basis. The generative AI model 500 recomputes the KV vectors by storing the token that was output for each batch by the previous layer at each layer for every decode phase for every token and pre-scheduling QKV calculations of the KV vectors for all previous tokens for the layer using the preserved tokens. The generative AI model 500 then schedules the decode computation for the current token and layer.

To illustrate with reference to FIG. 5, beginning with a prefill phase 501, rather than storing the plurality of keys 206 and the plurality of values 208 that were generated during execution of the prefill phase 501 by a first layer P-L1 502 during execution by a second layer P-L2 512 of the prefill phase 501, the generative AI model 500 discards the plurality of keys 206 and the plurality of values 208 that were generated by the first layer P-L1 502 during execution of the prefill phase 501, leaving only the plurality of keys 214 and the plurality of values 216 as KV cache 204 during execution by the second layer P-L2 512 of the prefill phase 501. The plurality of keys 214 and the plurality of values 216 are then discarded such that the only output of the prefill phase that is stored in the device memory 130 as KV cache 204 following execution of P-L2 512 is the first token 210.

Because the first layer of D-L1 522 uses the plurality of keys 206 and the plurality of values 208 as an input for execution of the decode phase 521 to generate a second token and because the plurality of keys 206 and the plurality of values 208 have been discarded and not saved as KV cache 204, the generative AI model 500 reinvokes the first layer P-L1 502 to re-execute the prefill phase to recompute the plurality of keys 206 and the plurality of values 208 just in time for consumption by D-L1 522. In response to P-L1 502 recomputing the plurality of keys 206 and the plurality of values 208, the generative AI model 500 schedules execution by the first layer D-L1 522 of the decode phase 521. Execution by the first layer D-L1 522 of the decode phase 521 generates the single key 218 and the single value 220, as well as a token 504. The single key 218 and the single value 220 are then discarded from the KV cache 204, while the token 504 is preserved in the KV cache 204 during execution by the second layer D-L2 532 of the decode phase 521.

Because execution by the second layer D-L2 532 of the decode phase 521 uses the plurality of keys 214 and the plurality of values 216 as an input and they are no longer included in the KV cache 204, the generative AI model 300 reinvokes the second layer P-L2 512 to re-execute the prefill phase 501 to recompute the plurality of keys 214 and the plurality of values 216 just in time for consumption by D-L2 532. In response to P-L2 512 recomputing the plurality of keys 214 and the plurality of values 216, the generative AI model 500 schedules execution by the second layer D-L2 532 of the decode phase 521. Execution by the second layer D-L2 532 of the decode phase 521 generates the single key 224 and the single value 226, as well as an output token 506. The single key 224 and the single value 226 are discarded from the KV cache 204 during execution by the first layer D-L1 542 of a decode phase 541, shown in FIG. 6, whereas the token 506 is saved in the device memory 130 as KV cache 204.

Continuing with FIG. 6, execution by the first layer D-L1 542 of the decode phase 541 to generate a third token requires as inputs the outputs from execution by the first layer D-L1 522 of the decode phase 521. However, the plurality of keys 206, the plurality of values 208, the single key 218, and the single value 220 have all been discarded from the KV cache 204. Therefore, the generative AI model 500 reinvokes the first layer P-L1 502 to re-execute the prefill phase 501 to recompute the plurality of keys 206 and the plurality of values 208. In addition, the generative AI model 500 pre-schedules QKV calculations 602 by the first layer D-L1 to recompute the single key 218 and the single value 220 for consumption by the first layer D-L1 542 during execution of the decode phase 541. In response to P-L1 502 recomputing the plurality of keys 206 and the plurality of values 208, and the QKV calculations 602 recomputing the single key 218 and the single value 220, the generative AI model 500 schedules execution by the first layer D-L1 542 of the decode phase 541. Execution of the first layer D-L1 542 of the decode phase 541 generates the single key 228 and the single value 230, as well as an output token 604. The single key 224 and the single value 226 are discarded from the KV cache 204 during execution by the second layer D-L2 552 of the decode phase 541, whereas the token 604 is saved in the device memory 130 along with the KV cache 204 of previously-generated tokens 210, 502, and 504.

Execution of the second layer D-L2 552 of the decode phase 541 requires as inputs the outputs from the execution by the second layer D-L2 532 of the decode phase 521. However, the plurality of keys 214, the plurality of values 216, the single key 224, and the single value 226 have all been discarded from the KV cache 204. Therefore, the generative AI model 500 reinvokes the second layer P-L2 512 to re-execute the prefill phase 501 to recompute the plurality of keys 214 and the plurality of values 216. In addition, the generative AI model 500 pre-schedules QKV calculations 606 for the second layer D-L2 to recompute the single key 224 and the single value 226 for consumption by the second layer D-L2 552 during execution of the decode phase 541. In response to P-L2 512 recomputing the plurality of keys 214 and the plurality of values 216, and the QKV calculations 606 recomputing the single key 224 and the single value 226, the generative AI model 500 schedules execution of the second layer D-L2 552 of the decode phase 541. Execution by the second layer D-L2 552 of the decode phase 541 generates the single key 234 and the single value 236, as well as an output token 608. The single key 234 and the single value 236 are discarded from the KV cache 204 during execution of the second layer D-L2 552 of the decode phase 541, whereas the token 608 is saved in the device memory 130 along with the KV cache 204 of previously-generated tokens 210, 502, 504, and 604. The process of discarding and recomputing the pluralities of keys 206, 214, the pluralities of values 208, 216, and the single keys and values repeats for each successive execution by the first and second layer, respectively, of the decode phase for each subsequent token. As will be apparent from a comparison of the amount of KV cache 204 for execution by the second layer D-L2 552 of the decode phase 541 illustrated in FIG. 6 versus the amount of KV cache 204 for execution by the second layer D-L2 252 of the decode phase 241 illustrated in FIG. 2, significant reductions in KV cache 204 are achieved by selectively discarding and recomputing the KV vectors as needed, just in time for consumption by a current layer executing the decode phase.

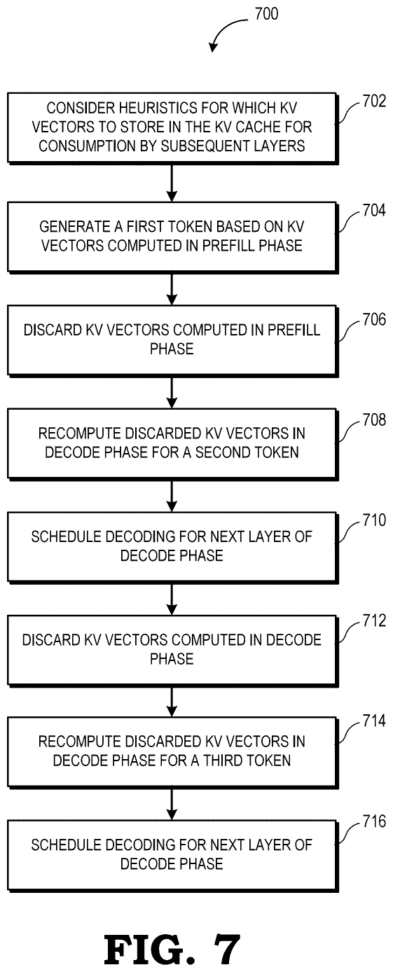

FIG. 7 is a flow diagram illustrating a method 700 for selectively discarding and recomputing prefill and/or decode key and value vectors in decode phases of a generative artificial intelligence model in accordance with some embodiments. In some embodiments, the method 700 is performed at a processing system such as the processing system 100 executing a generative AI model such as generative AI model 300 or generative AI model 500.

At step 702, a machine learning framework such as a runtime executing at the processing system 100 determines an extent to which KV vectors for the generative AI model will be discarded and recomputed based on heuristics such as the capacity of internal memory 130 that is available to be allocated for KV cache 204, the characteristics of the generative AI model that is executing, and the batch size (i.e., number of users/queries). In some implementations, hints regarding a degree of target re-computation are received from a user (programmer). The runtime assesses other concurrent computations in the processing system 100 to determine memory capacity pressure and implements a policy of a degree of discard and re-computation based on the determined memory capacity pressure. For example, in some instances, the runtime determines that the available memory for storing KV cache 204 (whether at internal memory 130 or elsewhere in the processing system 100)is so small that all prefill and decode KV vectors should be discarded after generation and recomputed on an as-needed basis just in time for consumption by a subsequent layer of the generative AI model, as illustrated in the generative AI model 500 of FIGS. 5 and 6. In other instances, the runtime determines that the available memory for storing KV cache 204 is large enough to store some percentage of KV vectors after generation, e.g., no prefill KV vectors (which tend to be larger), but all decode KV vectors (which have a single key and value for each batch), as illustrated in the generative AI model 300 of FIGS. 3 and 4. In yet other instances, the runtime determines that the KV cache 204 size can accommodate storing the KV vectors for some but not all layers'execution of precode and/or decode phases for various tokens.

At step 704, the first layer executes the prefill phase to generate a plurality of keys and a plurality of values that will subsequently be consumed by the first layer when it executes the decode phase for each token. The keys and values are stored as KV cache while the second layer's execution of the prefill phase generates a plurality of keys and a plurality of values that will subsequently be consumed by the second layer's execution of the decode phase for each token. The output of the prefill phase is a first token.

At step 706, the processing system discards the keys and values (KV vectors) that were computed by one or more of the layers during execution of the prefill phase such that the KV vectors are no longer stored as KV cache. In some implementations, the only output of the prefill phase that is stored as KV cache following execution by the second (or last) layer of the prefill phase is the first token.

At step 708, the decode phase for the first token commences. The processing system reinvokes the first layer to re-execute the prefill phase to recompute the plurality of keys and the plurality of values that the first layer's execution of the prefill phase had previously computed during the prefill phase just in time for consumption by the first layer in its execution of the decode phase for the second token.

At step 710, in response to the first layer re-executing the prefill phase to recompute the plurality of keys and the plurality of values, the processing system schedules execution by the first layer of the decode phase for the second token. The first layer's execution of the decode phase for the second token generates the single key and the single value, as well as an output token.

At step 712, the processing system discards the single key and the single value from the KV cache while preserving the output tokens of the first layer in the KV cache during execution by the second layer of the decode phase for the second token.

At step 714, the processing system reinvokes the first layer to re-execute the prefill phase to recompute the plurality of keys and the plurality of values that were originally computed by the first layer when it executed the prefill phase. In addition, the processing system pre-schedules QKV calculations for the first layer for its execution of the decode phase for the second token to recompute the single key and the single value for consumption by the first layer in its execution of the decode phase for the third token.

At step 716, in response to the first layer's execution of the prefill phase recomputing the plurality of keys and the plurality of values and the QKV calculations recomputing the single key and the single value that were previously computed by the first layer's execution of the decode phase for the second token, the processing system schedules execution by the first layer of the decode phase for the third token. Execution by the first layer of the decode phase for the third token generates a single key and a single value, as well as an output token.

Although the method 700 described above illustrates selectively discarding and recomputing KV vectors by a first layer of a generative artificial intelligence inference model in its execution of prefill and decode phases for the first three tokens, a similar method is employed for a second layer (and any additional layers) of generative artificial intelligence inference model in their execution of prefill and decode phases for the first three and any additional tokens. The extent to which selective re-computation of KV vectors is performed (e.g., only for prefill KV vectors, for both prefill and decode KV vectors, for a percentage of layers or a percentage of KV vectors, etc.) is determined based on the determinations of the runtime as described with respect to step 702. In addition, in some implementations, the runtime coalesces re-computation of KV vectors for multiple layers and/or tokens based on available memory capacity for storing KV cache and system requirements.

In some embodiments, the apparatus and techniques described above are implemented in a system including one or more integrated circuit (IC) devices (also referred to as integrated circuit packages or microchips), such as the processing system described above with reference to FIGS. 1-7. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry, etc.) are described or claimed as “configured” to perform one or more tasks or operations. This formulation-[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
generating a first token based on key and value vectors computed in a first layer and a second layer of a generative artificial intelligence inference model;
selectively discarding the key and value vectors; and
selectively recomputing the discarded key and value vectors for consumption by the first layer and the second layer to generate a second token.

2. The method of claim 1, wherein the first token is generated during execution of a prefill phase of the generative artificial intelligence inference model and wherein selectively recomputing comprises selectively recomputing the discarded key and value vectors from execution by the first layer of the prefill phase for consumption by the first layer during execution of a decode phase.

3. The method of claim 2, further comprising:
scheduling execution by the first layer of the decode phase to generate the second token in response to selectively recomputing the discarded key and value vectors.

4. The method of claim 3, further comprising:
selectively discarding key and value vectors computed in the execution by the first layer of the decode phase to generate the second token; and
selectively recomputing the discarded key and value vectors computed in the execution by the first layer of the decode phase to generate the second token for consumption by the first layer during execution of the decode phase to generate a third token.

5. The method of claim 3, further comprising:
selectively recomputing the discarded recomputed key and value vectors from the execution by the second layer of the prefill phase for consumption by the second layer during execution of the of the decode phase to generate the second token.

6. The method of claim 5, further comprising:
scheduling execution by the second layer of the decode phase to generate the second token in response to selectively recomputing the discarded recomputed key and value vectors.

7. The method of claim 6, further comprising:
selectively discarding key and value vectors computed by the execution by the second layer of the decode phase to generate the second token; and
selectively recomputing the discarded key and value vectors computed by the execution by the second layer of the decode phase to generate the second token for consumption by the second layer during execution of the decode phase to generate a third token.

8. The method of claim 2, further comprising:
selectively coalescing re-computation of the discarded key and value vectors in one or more additional layers of the decode phase for one or more additional tokens.

9. The method of claim 1, wherein selectively discarding comprises discarding an amount of key and value vectors based on at least one of a memory capacity to store the key and value vectors, the generative artificial intelligence inference model, and a number of users of the generative artificial intelligence inference model.

10. A processing system, comprising:
a memory configured to store key and value vectors; and
one or more processors configured to:
generate a first token based on key and value vectors computed in a first layer and a second layer of a generative artificial intelligence inference model;
selectively discard the key and value vectors; and
selectively recompute the discarded key and value vectors for consumption by the first layer and the second layer to generate a second token.

11. The processing system of claim 10, wherein the one or more processors are further configured to:
generate the first token during execution of a prefill phase of the generative artificial intelligence inference model; and
selectively recompute the discarded key and value vectors that were generated from execution by the first layer of the prefill phase for consumption by the first layer during execution of a decode phase of the generative artificial intelligence inference model.

12. The processing system of claim 11, wherein the one or more processors are further configured to:
schedule execution by the first layer of the decode phase to generate the second token in response to selectively recomputing the discarded key and value vectors.

13. The processing system of claim 12, wherein the one or more processors are further configured to:
selectively discard key and value vectors computed in the execution by the first layer of the decode phase to generate the second token; and
selectively recompute the discarded key and value vectors computed in the execution by the first layer of the decode phase to generate the second token for consumption by the first layer during execution of the decode phase to generate a third token.

14. The processing system of claim 12, wherein the one or more processors are further configured to:
selectively recompute the discarded recomputed key and value vectors from the execution by the second layer of the prefill phase for consumption by the second layer during execution of the decode phase to generate the second token.

15. The processing system of claim 14, wherein the one or more processors are further configured to:
schedule execution by the second layer of the decode phase to generate the second token in response to selectively recomputing the discarded recomputed key and value vectors.

16. The processing system of claim 15, wherein the one or more processors are further configured to:
selectively discard key and value vectors computed by the execution by the second layer of the decode phase to generate the second token; and
selectively recompute the discarded key and value vectors computed by the execution by the second layer of the decode phase to generate the second token for consumption by the second layer during execution of the decode phase to generate a third token.

17. The processing system of claim 11, wherein the one or more processors are further configured to:
selectively coalesce re-computation of the discarded key and value vectors in one or more additional layers of the decode phase for one or more additional tokens.

18. The processing system of claim 10, wherein the one or more processors are further configured to:
selectively discard an amount of key and value vectors based on at least one of an available capacity of the memory to store the key and value vectors, the generative artificial intelligence inference model, and a number of users of the generative artificial intelligence inference model.

19. A method comprising:
selectively discarding key and value vectors computed by a generative artificial intelligence inference model to generate a first token; and
selectively recomputing the discarded key and value vectors for consumption by a layer of for the generative artificial intelligence inference model to generate a second token.

20. The method of claim 19, wherein selectively discarding comprises discarding an amount of key and value vectors based on at least one of a memory capacity to store the key and value vectors, the generative artificial intelligence inference model, and a number of users of the generative artificial intelligence inference model.
